(19) United States
(12) Patent Application Publication
(10) Pub. No.: US 2014/0008956 A1
(43) Pub. Date: Jan. 9, 2014

(54) CONTINUOUS MANUAL RECLINER WITH INTEGRATED LOCK

(71) Applicant: Lear Corporation, Southfield, MI (US)

(72) Inventors: B. Paul Golarz, West Bloomfield, MI (US); Kenneth McQueen, Leonard, MI (US); Robert Wahls, Commerce Twp., MI (US); James S. Wawrzyniak, Warren, MI (US)

(21) Appl. No.: 13/919,269

(22) Filed: Jun. 17, 2013

Related U.S. Application Data
(60) Provisional application No. 61/667,708, filed on Jul. 3, 2012.

(51) Int. Cl. B60N 2/225

(52) U.S. Cl. CPC B60N 2/225
USPC 297/354.1

(57) ABSTRACT

A continuous manual seat recliner mechanism with an integrated lock includes an upper gear plate and lower gear plate in geared connection with the upper gear plate. The upper gear plate is able to rotate eccentrically in relation to the lower gear plate. A coiled locking spring is located within a central bore of a lock cylinder which is fixed to the lower gear plate so that an outside surface of the locking spring may frictionally engage the lock cylinder to prevent the lock cylinder and, thereby, the lower gear, from rotating. The ends of the lock spring engage with a knob hub and a driver hub such that rotation of the knob hub unlocks the recliner to allow adjustment by the operator, while rotation of the driver hub locks the recliner mechanism.

### CROSS-REFERENCE TO RELATED APPLICATIONS

This application claims the benefit of U.S. provisional Application No. 61/667,708 filed Jul. 3, 2012, the disclosure of which is incorporated in its entirety by reference herein.

### BACKGROUND

Vehicle seats normally include a seat cushion and a seat back. Reclining mechanisms are provided for vehicle seats to permit the seat back to be positioned at a desired angular orientation relative to the seat cushion to provide a seating position that is comfortable to a seat occupant. Reclining mechanisms for vehicle seats permit the seat back to be selectively pivoted by the seat occupant to recline or incline the seat. Continuous reclining mechanisms have constantly engaged inter-fitting gears that are rotated to adjust the angle of inclination of the seat.

Continuous reclining mechanisms, such as that disclosed in U.S. Pat. No. 7,513,573, issued Apr. 7, 2009, which is incorporated herein by reference, discloses a continuous engagement seat adjuster. The seat adjuster has gears with offset centers of rotation that remain engaged at all times. One of the gears is rotated against the other gear to adjust the angular orientation of the seat. The gears remain engaged to lock the seat in place.

Continuous recliner mechanisms may be power driven (such as by an electric drive motor) as shown in U.S. Pat. No. 7,513,573, or, alternatively, may be manually operated, such as is shown in U.S. Pat. No. 7,878,593, issued Feb. 1, 2011. Other known continuous recliner mechanisms are disclosed in U.S. Pat. Nos. 5,871,414 and 6,619,743.

One of the problems associated with conventional continuous manual recliner technology is that forces that may be applied to the seat back during dynamic operating conditions may result in the inclination of the seat back changing or creeping to a position that differs from that at which the seat back was initially set. Thus, a need has arisen to avoid periodic unwanted adjustment.

### SUMMARY

The present invention relates to an integrated locking (or anti back-drive) device for releasably securing a seat back with respect to a seat cushion. The locking device is integrated into a continuous manual recliner mechanism, which typically employs an upper gear plate that is affixed to the seat back. The upper gear plate defines gear teeth. A lower gear plate is secured to a seat bottom and defines gear teeth that cooperate with the gear teeth of the upper plate. The upper gear plate is able to rotate about an axis of rotation that is displaced from an axis associated with the lower gear plate so that the upper gear plate may rotate eccentrically in relation to the lower gear plate. At least one wedge is mounted in relation to the upper gear plate. A wedge spring engages the at least one wedge that biases the at least one wedge arcuately and outwardly so that at least one wedge may engage an inner surface of the lower gear and the outer surface of the flange extending from the center of the upper gear.

A control knob handle is mounted for rotation to allow the operator to adjust the inclination of the seat back rest by rotating the handle.

The locking mechanism includes a locking spring located within a central bore of a lock cylinder which is rotatively fixed with respect to the lower gear plate so that an outside surface of the locking spring may frictionally engage the lock cylinder to prevent the lock cylinder and, thereby, the lower gear, from rotating. The ends of the lock spring extend radially between projections on the knob handle hub and a driver hub such that rotation of the knob handle (and knob hub) reduces the diameter of the locking spring, allowing the spring to rotate within the lock cylinder and thereby unlocking the recliner mechanism to allow adjustment by the operator, while rotation of the driver hub (due, for example, to forces applied to the seat back rest) increases the diameter of the locking spring, bringing the outer surface of the spring into frictional contact with the inner wall of the lock cylinder thereby locking the recliner mechanism and preventing unwanted adjustment of the seat back.

### BRIEF DESCRIPTION OF THE DRAWINGS

FIG. 1 is an exploded, perspective view of a continuous manual recliner device according to one embodiment of the present invention;

FIG. 2 is a side cross-sectional view taken through the center of the manual recliner;

FIG. 3 is an end cross-sectional view taken through the location of the locking spring, showing the recliner mechanism in the neutral position;

FIG. 4 is an end cross-sectional view taken through the location of the locking spring, showing the recliner mechanism when the control knob has been rotated in the clockwise direction;

FIG. 5 is an end cross-sectional view taken through the location of the locking spring, showing the recliner mechanism when the control knob has been rotated in the counterclockwise direction;

FIG. 6 is an end cross-sectional view taken through the location of the locking spring, showing the recliner mechanism when the driver hub has been rotated in the clockwise direction;

FIG. 7 is an end cross-sectional view taken through the location of the locking spring, showing the recliner mechanism when the driver hub has been rotated in the counterclockwise direction; and

FIG. 8 is an exploded view of an alternative embodiment of the lock including a metal friction bushing.

### DETAILED DESCRIPTION

As required, a detailed embodiment of the present invention is disclosed herein; however, it is to be understood that the disclosed embodiment is merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the teachings of the present invention.

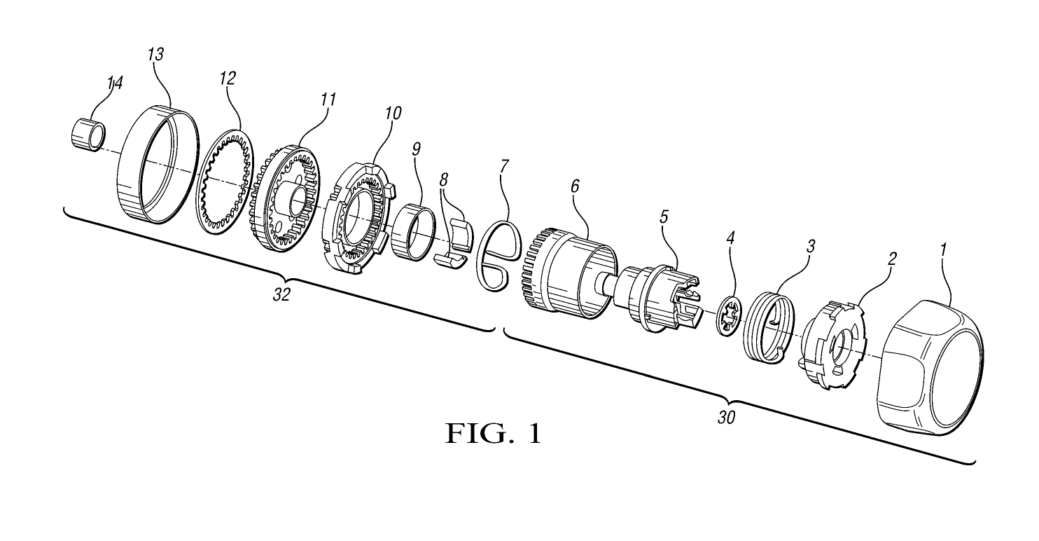

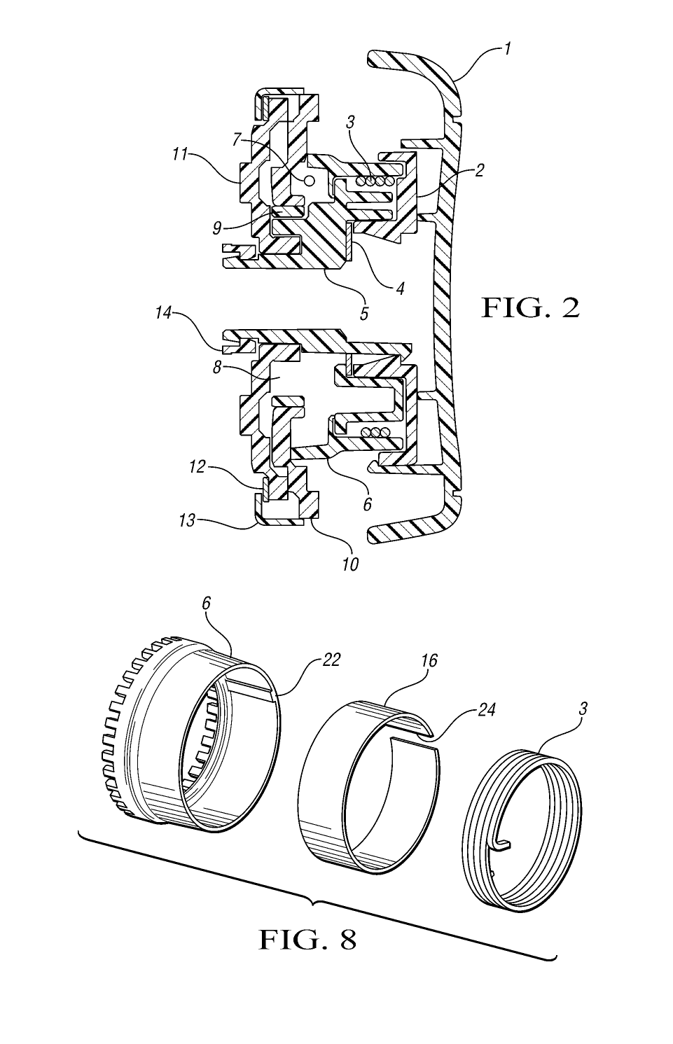

Referring to FIGS. 1 and 2, the disclosed continuous recliner with integrated lock is part of a continuous manual adjustment mechanism that may be incorporated in a seat. The lock mechanism 30 is integrated into a conventional manual continuous recliner mechanism 32.

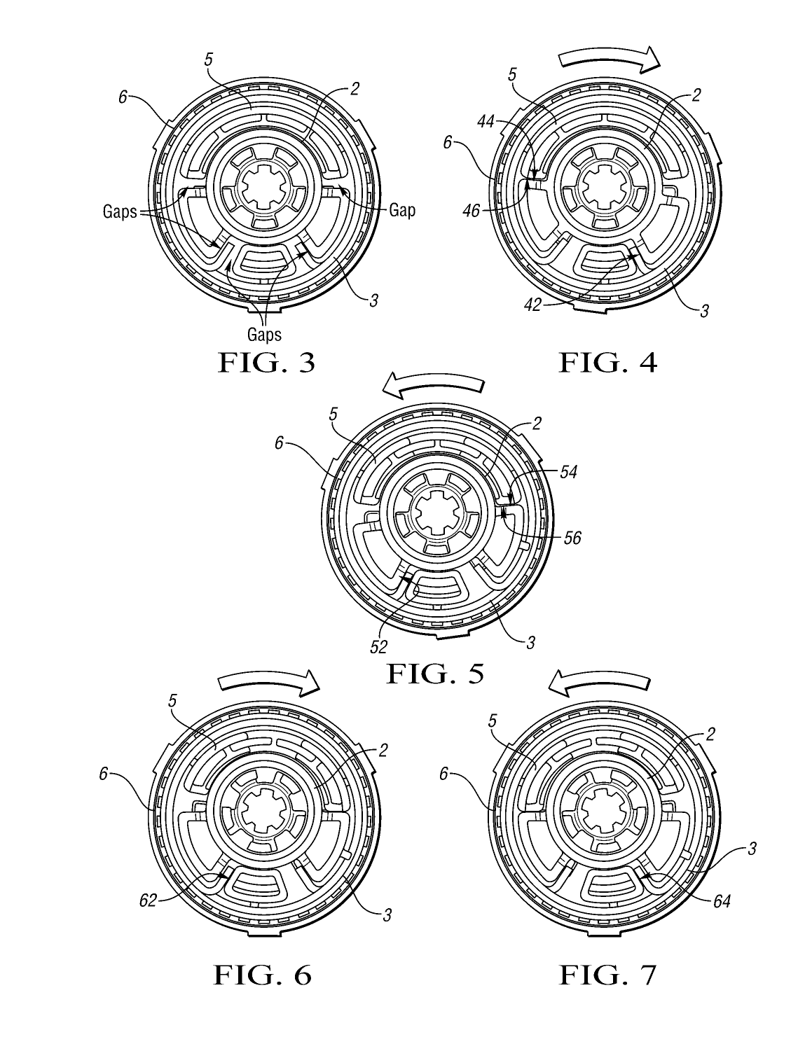

The lock mechanism 30 includes a lock cylinder 6 including teeth which engage teeth on the inner circumferential surface of the lower gear 10 of the recliner mechanism to prevent rotation of the lock cylinder 6 relative to the lower gear 10. A driver hub 5 is mounted within the lock cylinder and includes a flange which extends through the center of the components of the recliner mechanism and is fixedly connected to clip 14. A locking spring 3 is mounted to surround the outer surface of the driver hub 5 such that the outer surfaces of the spring coils are contained within and surrounded by the inner wall of the locking cylinder 6. A nob hub 2 is mounted to surround and extend within the locking spring 3 as well as a portion of the driver hub 5, such that the knob hub 2 may be rotated relative to the driver of 5 and the locking spring 3. A knob handle 1 is preferably secured to the knob of 3 to allow an operator to rotate the handle 1 and the knob hub 2 to adjust the seat back inclination. Each of the knob hub 2 and driver hub 5 includes a series of projections (shown in FIGS. 3-7, and further described hereinafter) which, upon rotation, contact the ends of the locking spring 3 to decrease and increase, respectively, the circumference of the locking spring 32 thereby, respectively, unlock and lock the recliner mechanism.

The continuous recliner mechanism 32 may be any of various conventional continuous disk-type recliner mechanisms currently commercially available. In the illustrated embodiment, the recliner mechanism 32 includes a lower gear plate 10 that is received in an upper gear plate 11. A cup shaped laser weld ring 13 partially encloses the lower and upper gear plates 10, 11. A plastic glider 12 is provided between the upper gear plate 11 and the weld ring 13 to reduce friction and minimize noise and vibration in the device. A pair of wedges 8 are mounted to engage the inner surface of the lower gear 10 (indirectly, by engaging the inner wall of bushing 9 which is friction fit within lower gear 10), as well as the outer surfaces of the central extending flange on upper gear 11. Wedge spring 7 urges each of the wedges 8 into frictional contact with each of the lower gear 10 an upper gear 11.

The following description assumes that the upper gear plate 11 is attached to a movable seat back (not shown) and that the lower gear plate 10 is attached to a seat bottom or cushion (also not shown), which is fixed if not moved in relation to a track. The lower gear 10 is eccentrically mounted relative to the movable upper gear 11. The wedges are supported, as previously described, within the space between the inner circumferential surface of the lower gear 10 and the axially extending flange of the upper gear 11. The wedge spring 7 biases the wedges 8 so that teeth on the meeting surfaces of lower gear 10 an upper gear 11 are engaged.

Referring now to FIGS. 3-7, the assembled continuous manual recliner mechanism with integrated lock is described in various stages of operation. FIG. 3 depicts the recliner mechanism in a neutral position (that is, unbiased by external forces). When assembled, the coiled portion of locking spring 3 is mounted within the inner wall of lock cylinder 6 with various projections from each of the knob hub 2 and driver hub 5 extending axially within the coil. In the illustrated embodiment, a small amount of clearance, for example, about 0.7 mm, is provided between the outer surface of the coiled locking spring 3 and the inner wall of the lock cylinder 6. This clearance should be sufficient to allow the contracted spring to rotate smoothly within the lock cylinder 6 when the device is unlocked, yet provide sufficient frictional contact between the spring and the lock cylinder 6 when the spring is enlarged to lock the recliner mechanism.

The ends of the locking spring 3 each extend radially inwardly to interact with projections on the knob hub 2 and the driver hub 5 as hereinafter described. In the illustrated embodiment, the spring ends extend at an angle of 90° from the plane of the spring coils.

Referring to FIG. 4, in the event the knob handle 1 (and knob hub 2) are rotated in the clockwise direction, a projection 42 contacts and moves the locking spring in the clockwise direction. The locking spring diameter is reduced, and the locking spring 3 slides inside the lock cylinder 6 with little friction (i.e., the recliner mechanism is unlocked for adjustment). Knob hub projection 44 then contacts driver hub projection 46, thereby driving the recliner mechanism to adjust the seat back inclination as desired.

If the operator rotates the knob handle 1 in the counterclockwise direction (as shown in FIG. 5), knob hub projection 52 contacts and moves the locking spring end in the counterclockwise direction. Again, the locking spring diameter is reduced, and the recliner mechanism is unlocked for adjustment. Knob hub projection 54 then contacts driver hub projection 56, thereby driving the recliner mechanism to adjust the seat back inclination as desired.

Referring now to FIG. 6, if the driver hub 5 is rotated in the clockwise direction, as a result, for example, of a rearward force being applied to the seat back, projection 62 on driver hub 5 contacts and moves the end of the locking spring 3 in the clockwise direction, expanding the spring's diameter, thereby causing frictional contact between the outer surface of locking spring three and the inner surface of lock cylinder 6, thereby locking the recliner mechanism from further rotation.

Similarly, as shown in FIG. 7, if the driver hub 5 is rotated in the counterclockwise direction, as a result, for example, of a forward force being applied from behind the seat back, projection 64 on driver hub 5 contacts and moves the end of locking spring 3 in the clockwise direction, expanding the spring's diameter, thereby causing frictional contact between the outer surface of the locking spring three and the inner surface of lock cylinder 6, thereby locking the recliner mechanism from further rotation.

It should be noted that sufficient gaps are provided between each of the projections on the knob hub 2, the driver hub 5, and the locking spring ends to allow for adequate rotation to lock and unlock the device without interference from these various components. In the illustrated embodiment, a gap of about 16° of rotation is provided. This gap has been found to be sufficient to allow operation of the knob hub 2 without interference between the projections on the knob hub 2 and the projections on the driver hub 5 and/or the locking spring ends. The optimum gaps may, of course, be modified, depending upon the size and design of the interacting components, as well as the responsiveness desired.

In the illustrated embodiment, the lock cylinder 6 is preferably formed of a suitable plastic material. However, as illustrated in FIG. 8, in an alternative embodiment, a metal bushing 16 may be utilized to provide a greater frictional contact surface with locking spring 3 to allow the lock to withstand greater applied forces. In the illustrated embodiment, bushing 16 is split, at 24, to interlock with a land 22 provided on the inside surface of the lock cylinder 6 to prevent relative rotation between the bushing 16 and the lock cylinder 6.

The locking mechanism 30 is assembled with the continuous recliner mechanism 32 to provide an integrated manual locking seat adjuster. In assembling the disclosed mechanism, the bushing 9 is mounted within the inner diameter of the lower gear 10. Then the lower gear 10 is mounted within the inside of the upper gear 11. Then the glider 12 is inserted on the inside of laser weld ring 13. The wedges 8 are then assembled on the inside of bushing 9, and the splines that extend from wedge spring 7 are inserted into the notches that are defined within the wedges 8. The lock cylinder 6 and positioned into contact with lower gear 10 and the driver hub 5 is inserted within lock cylinder 6 such that the end of driver hub 5 extends within upper gear 11, and is secured in that position by driver clip 14 that is placed on the outside of the upper gear 11. Seal 4, locking spring 3, and knob hub 2 are secured in place surrounding driver hub 5 and within lock cylinder 6 (as illustrated in FIG. 2). Knob handle 1 is typically secured to knob hub 2 in a separate operation after the entire seat assembly is near completion.

It will be appreciated that in practice there are a number of alternative ways for securing the components of the assembly together. By way of non-limiting examples, TIG welding, MIG welding, or laser welding are illustrative approaches.

It will also be appreciated that the integration of the locking mechanism 30 with the continuous recliner mechanism 32 allows for the recliner and lock to be assembled in a single operation at the same location. This integrated design thus simplifies assembly and reduces assembly and installation costs in comparison to other retrofitted manual recliner lock mechanisms. The remaining component, knob handle 1, may then be assembled upon completion of the assembly of the seat.

A list of reference numerals and the components to which they refer now follows:

| Ref. No. | Component |
|---|---|
| 1 | Knob Handle |
| 2 | Knob Hub |
| 3 | Locking Spring |
| 4 | Seal |
| 5 | Driver Hub |
| 6 | Lock Cylinder |
| 7 | Wedge Spring |
| 8 | Wedges |
| 9 | Bushing |
| 10 | Lower Gear |
| 11 | Upper Gear |
| 12 | Glider |
| 13 | Laser Weld Ring |
| 14 | Clip |
| 16 | Lock Cylinder Bushing |

While exemplary embodiments are illustrated and described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A manual recliner mechanism for a vehicle seat comprising:
an upper gear plate having a first plurality of internal teeth disposed in a circular array on one side of the upper gear plate and having a first axis of rotation, said upper gear further including a centrally extending flange defining a first circumferential bearing surface;
a lower gear plate having a second plurality of external teeth disposed in a circular array on one side of the lower gear plate and having a second center of rotation that is offset from the first axis of rotation, wherein the upper and lower gear are engaged at one location on each gear so that rotation of one gear causes one gear to orbit relative the other gear, and wherein the lower gear plate defines a second circumferential bearing surface;
an expandable cam assembly including at least one wedge disposed between the first circumferential bearing surface and the second circumferential bearing surface, wherein the at least one wedge is movable to selectively engage the second circumferential bearing surface, and a wedge spring which engages the at least one wedge and biases the at least one wedge into engagement with the second circumferential bearing surface to selectively lock the cam assembly to the second circumferential bearing surface;
a lock cylinder engaged with the lower gear plate, the lock cylinder including a third circumferential bearing surface defined on the inner wall of the lock cylinder;
a driver hub assembled to the cam assembly and operable when rotated to bias the expandable cam assembly out of locking engagement with the second circumferential bearing surface of the lower gear plate, thereby allowing for selective rotation of the upper gear with respect to the lower gear, said driver hub further including an axially extending circumferential surface including a first set of projections;
a coiled locking spring mounted within the inner wall of the lock cylinder and surrounding the axially extending circumferential surface of the driver hub, and
a knob hub including an axially extending portion which extends within the coiled locking spring, wherein the axially extending portion includes a second set of projections, wherein
the locking spring further includes first and second ends which extend radially inward at an angle of about 90 degrees from plane of the coil such that the first and second ends are alternatively engageable with the first and second set of projections on the driver hub and the knob hub, whereby rotation of the driver hub relative to the nob hub results in engagement of the first projections with the first and second ends, thereby expanding the coil spring into locking engagement with the third circumferential bearing surface defined on the inner wall of the lock cylinder, thereby locking the recliner mechanism from further rotation, and whereby rotation of the nob hub results in engagement of the second projections with the first and second ends, thereby contracting the coil spring out of locking engagement with the third circumferential bearing surface defined on the inner wall of the lock cylinder, and unlocking the recliner mechanism for further rotation of the lower gear relative to the upper gear.

2. The manual recliner mechanism of claim 1 wherein the cam assembly includes a pair of wedges disposed between the first circumferential bearing surface and the second circumferential bearing surface, wherein each of the pair of wedges is movable to selectively engage the second circumferential bearing surface, and a wedge spring which engages each of the pair of wedges and biases each wedge into engagement with the second circumferential bearing surface to selectively lock the cam assembly to the second circumferential bearing surface.

3. The manual recliner mechanism of claim 1 wherein the lower gear further includes a first bushing friction fitted into the central opening of the lower gear, wherein the inner surface of the first bushing is the second circumferential bearing surface.

4. The manual recliner mechanism of claim 1 further including a knob handle secured to the knob hub to facilitate rotation of the knob hub.

5. The manual recliner mechanism of claim 1 wherein the lock cylinder further includes a second bushing friction fitted into the inner wall of the lock cylinder, wherein the inner surface of the bushing is the third circumferential bearing surface.

6. The manual recliner mechanism of claim 5 wherein the lock cylinder further includes a land which extends radially inward from the inner wall of the lock cylinder, the second bushing is split, and the split bushing interlocks with the land to prevent relative motion between the second bushing and the lock cylinder.

7. A manual recliner mechanism for a vehicle seat comprising:
an upper gear plate having a first axis of rotation, said upper gear further including a central, axially extending flange defining a first circumferential bearing surface;
a lower gear plate in geared connection with the upper gear plate and having a second center of rotation that is offset from the first axis of rotation, wherein the upper and lower gear plates are engaged so that rotation of one gear plate causes one gear plate to orbit relative the other gear plate, and wherein the lower gear plate defines a second circumferential bearing surface;
an expandable cam assembly for movement between locking and allowing rolling movement of the upper and lower gear plates;
a lock cylinder engaged with the lower gear plate, the lock cylinder including a third circumferential bearing surface defined on the inner wall of the lock cylinder;
a driver hub assembled to the cam assembly for expanding the cam assembly, said driver hub further including an axially extending circumferential surface including a first set of projections;
a coiled locking spring mounted within the inner wall of the lock cylinder and surrounding the axially extending circumferential surface of the driver hub, and
a knob hub including an axially extending portion which extends within the coiled locking spring, wherein the axially extending portion includes a second set of, wherein
the locking spring further includes first and second ends which are alternatively engageable with the first and second set of projections on the driver hub and the knob hub, whereby rotation of the driver hub relative to the nob hub results in engagement of the first projections with the first and second ends, thereby expanding the coil spring into locking engagement with the third circumferential bearing surface defined on the inner wall of the lock cylinder, thereby locking the recliner mechanism from further rotation, and whereby rotation of the nob hub results in engagement of the second projections with the first and second ends, thereby contracting the coil spring out of locking engagement with the third circumferential bearing surface defined on the inner wall of the lock cylinder, and unlocking the recliner mechanism for further rotation of the lower gear relative to the upper gear.

8. The manual recliner mechanism of claim 7 wherein the first and second ends of the locking spring extend radially inward at an angle of about 90 degrees from plane of the coil such that the first and second ends are alternatively engageable with the first and second set of projections on the driver hub and the knob hub.

9. The manual recliner mechanism of claim 7 wherein the cam assembly includes at least one wedge disposed between the first circumferential bearing surface and the second circumferential bearing surface, and wherein the at least one wedge is movable to selectively engage the second circumferential bearing surface, and a wedge spring which engages the at least one wedge and biases the at least one wedge into engagement with the second circumferential bearing surface to selectively lock the cam assembly to the second circumferential bearing surface.

10. The manual recliner mechanism of claim 7 wherein the cam assembly includes a pair of wedges disposed between the first circumferential bearing surface and the second circumferential bearing surface, wherein each of the pair of wedges is movable to selectively engage the second circumferential bearing surface, and a wedge spring which engages each of the pair of wedges and biases each wedge into engagement with the second circumferential bearing surface to selectively lock the cam assembly to the second circumferential bearing surface.

11. The manual recliner mechanism of claim 7 wherein the lower gear further includes a first bushing friction fitted into the central opening of the lower gear, wherein the inner surface of the first bushing is the second circumferential bearing surface.

12. The manual recliner mechanism of claim 7 wherein the lock cylinder further includes a second bushing friction fitted into the inner wall of the lock cylinder, wherein the inner surface of the bushing is the third circumferential bearing surface.

13. The manual recliner mechanism of claim 12 wherein the lock cylinder further includes a land which extends radially inward from the inner wall of the lock cylinder, the second bushing is split, and the split bushing interlocks with the land to prevent relative motion between the second bushing and the lock cylinder.

14. The manual recliner mechanism of claim 7 further including a knob handle secured to the knob hub to facilitate rotation of the knob hub.

15. A manual recliner mechanism for a vehicle seat comprising:
an upper gear plate having a first axis of rotation, said upper gear further including a centrally extending flange defining a first circumferential bearing surface;
a lower gear plate in geared connection with the upper gear plate and having a second center of rotation that is offset from the first axis of rotation, wherein the upper and lower gear plates are engaged so that rotation of one gear plate causes one gear plate to orbit relative the other gear plate, and wherein the lower gear plate defines a second circumferential bearing surface;
a pair of cam wedges for movement between a locking and allowing rolling movement of the upper and lower gear plates;
a lock cylinder engaged with the lower gear plate, the lock cylinder including a third circumferential bearing surface defined on the inner wall of the lock cylinder;
a driver hub assembled to the cam wedges for positioning the wedges, said driver hub further including an axially extending circumferential surface including a first set of projections;
a coiled locking spring mounted within the inner wall of the lock cylinder and surrounding the axially extending circumferential surface of the driver hub, and
a knob hub including an axially extending portion which extends within the coiled locking spring, wherein the axially extending portion includes a second set of, wherein
the locking spring further includes first and second ends which extend radially inward at an angle of about 90 degrees from plane of the coil and are alternatively engageable with the first and second set of projections on the driver hub and the knob hub, whereby rotation of the driver hub relative to the nob hub results in engagement of the first projections with the first and second ends, thereby expanding the coil spring into locking engagement with the third circumferential bearing surface defined on the inner wall of the lock cylinder, thereby locking the recliner mechanism from further rotation, and whereby rotation of the nob hub results in engagement of the second projections with the first and second ends, thereby contracting the coil spring out of locking engagement with the third circumferential bearing surface defined on the inner wall of the lock cylinder, and unlocking the recliner mechanism for further rotation of the lower gear relative to the upper gear.
